(19) United States
(12) Patent Application Publication
(10) Pub. No.: US 2023/0369817 A1
(43) Pub. Date: Nov. 16, 2023

(54) Electrical Extending Assembly

(71) Applicant: Kevin Hogan, Brooklyn, NY (US)

(72) Inventor: Kevin Hogan, Brooklyn, NY (US)

(21) Appl. No.: 17/742,118

(22) Filed: May 11, 2022

(51) Int. Cl. H01R 27/02

(52) U.S. Cl. CPC H01R 27/02; H01R 24/30

(57) ABSTRACT

An electrical extending assembly includes a power plug has a plurality of male contacts that can be plugged into a power source comprising a female electrical outlet. A member is coupled to and extends away from the power plug and the member is comprised of a flexible material thereby facilitating the member to be formed into a variety of shapes. A power housing is coupled to the member and the power housing is distally positioned with respect to the power plug. A plurality of first power ports each is integrated into the power housing to receive a first type of power cord. A plurality of second power ports is each is integrated into the power housing to receive a second type of power cord.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electrical extending devices and more particularly pertains to a new electrical extending device for facilitating a variety of different types of electronic devices to be plugged into a power source. The device includes a power plug, a flexible member coupled to the power plug and power housing attached to the member. A plurality of first power ports is recessed into the power housing and a plurality of second power ports is recessed into the power housing. Each of the first power ports can receive a first type of power port and each of the second power ports can receive a second type of power port.

### (2) Description of Related Art Including Information Disclosed Under 37 CFR 1.97 and 1.98

The prior art relates to electrical extending devices including an electrical socket device that includes a plurality of telescopic members. The prior art discloses an electrical socket extension that includes a tubular member and a female socket that is removably attached to an end of the tubular member. The prior art discloses a plurality of electrical extension devices that at least includes a telescopically adjustable member. The prior art discloses an electrical extension device that includes a flexible member extending between a male plug and a female plug.

### BRIEF SUMMARY OF THE INVENTION

An embodiment of the disclosure meets the needs presented above by generally comprising a power plug has a plurality of male contacts that can be plugged into a power source comprising a female electrical outlet. A member is coupled to and extends away from the power plug and the member is comprised of a flexible material thereby facilitating the member to be formed into a variety of shapes. A power housing is coupled to the member and the power housing is distally positioned with respect to the power plug. A plurality of first power ports each is integrated into the power housing to receive a first type of power cord. A plurality of second power ports is each is integrated into the power housing to receive a second type of power cord.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a electrical extending assembly according to an embodiment of the disclosure.

FIG. 2 is a front view of an embodiment of the disclosure.

FIG. 3 is a back view of an embodiment of the disclosure.

FIG. 4 is a right side view of an embodiment of the disclosure.

### DETAILED DESCRIPTION OF THE INVENTION

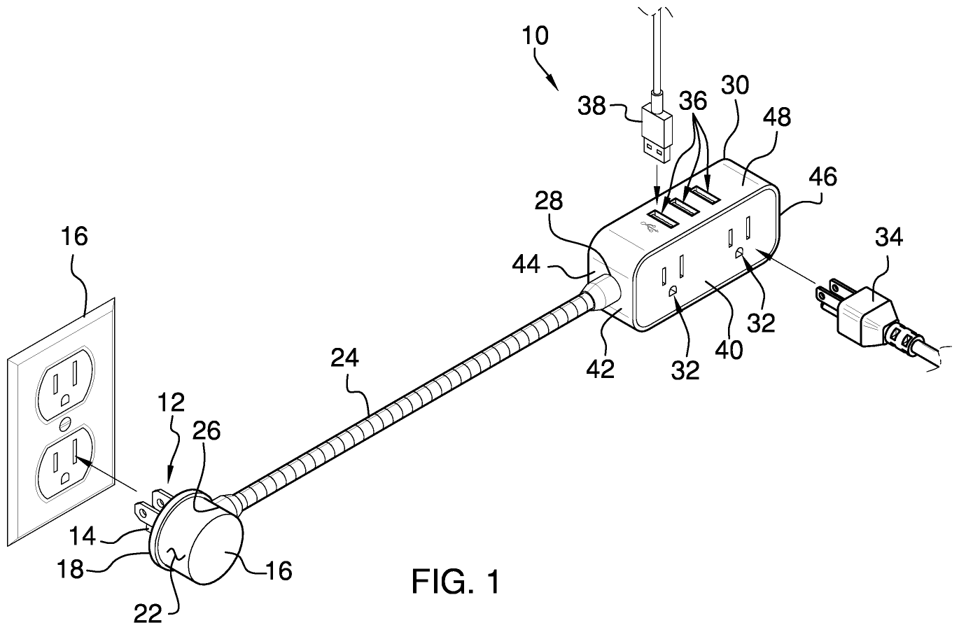

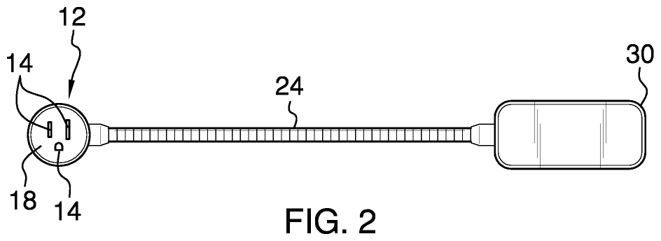

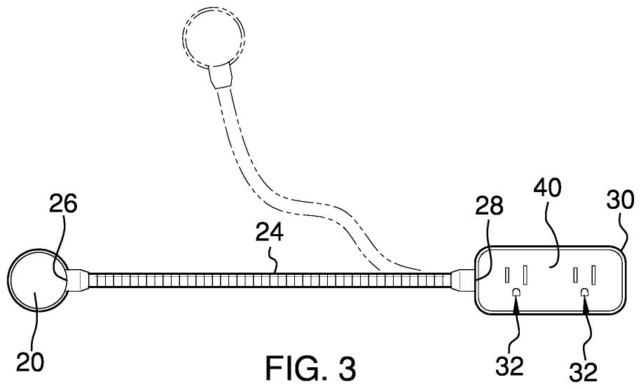

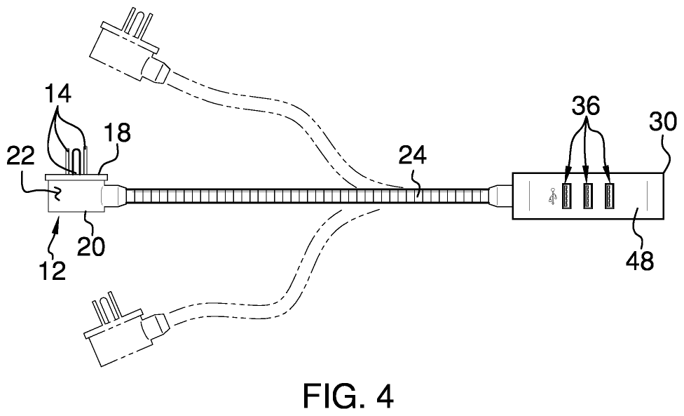

With reference now to the drawings, and in particular to FIGS. 1 through 4 thereof, a new electrical extending device embodying the principles and concepts of an embodiment of the disclosure and generally designated by the reference numeral 10 will be described.

As best illustrated in FIGS. 1 through 4, the electrical extending assembly 10 generally comprises a power plug 12 that has a plurality of male contacts 14 that can each be plugged into a power source 16 comprising a female electrical outlet. The female electrical outlet may be installed in a wall of building, such as a house or other building that would commonly be occupied by one or more individuals. The power plug 12 has a front face 18, a rear face 20 and a perimeter surface 22 extending between the front face 18 and the rear face 20, and each of the male contacts 14 extends away from the front face 18. Additionally, each of the male contacts 14 is comprised of an electrically conductive material.

A member 24 is provided and the member 24 is coupled to and extends away from the power plug 12. The member 24 is comprised of a flexible material thereby facilitating the member 24 to be formed into a variety of shapes. Additionally, the member 24 may have a length of at least 6.0 inches. The member 24 has a first end 26 and a second end 28, and the first end 26 is coupled to the perimeter surface 22 of the power plug 12. The member 24 may be comprised of a plurality of interconnected segments that can be oriented at a variety of angles with respect to each other.

A power housing 30 is provided and the power housing 30 is coupled to the member 24. The power housing 30 is distally positioned with respect to the power plug 12 thereby facilitating the power housing 30 to be distally positioned with respect to the power source 16 when the power plug 12 is plugged into the power source 16. The power housing 30 has a plurality of first power ports 32 that is each integrated into the power housing 30. In this way each of the first power ports 32 can receive a first type of power cord 34. Each of the first power ports 32 faces in an opposite direction with respect to the male contacts 14 on the power plug 12.

The power housing 30 has a plurality of second power ports 36 that is each integrated into the power housing 30 to receive a second type of power cord 38. Each of the second power ports 36 faces in a different direction than each of the first power ports 32. The power housing 30 has a rear wall 40 and an outer wall 42, and the outer wall 42 has a first lateral side 44, a second lateral side 46 and a top side 48. The power housing is elongated between the first lateral side 44 and the second lateral side 46. Additionally, the second end 28 of the member 24 is coupled to the first lateral side 44 having the rear wall 40 lying on a plane that is oriented substantially coplanar with the rear face 20 of the power plug 12.

Each of the first power ports 32 is recessed into the rear wall 40. Furthermore, the plurality of first power ports 32 may define a pair of female electrical outlets that can each receive a three prong male plug on a power cord. Additionally, each of the first power ports 32 is in electrical communication with the plurality of male contacts 14 on the front face 18 of the plug. Each of the second power ports 36 is recessed into the top side 48. Each of the second power ports 36 may comprise a universal serial bus port or other type of power port that is commonly associated with smart devices, including but not being limited to, smart phones and electronic tablets. Each of the second power ports 36 is in electrical communication with the plurality of male contacts 14 on the front face 18 of the plug.

In use, the male contacts 14 are plugged into the power source 16 such that each of the first power ports 32 and each of the second power ports 36 receive electrical power from the power source 16. In this way the first power ports 32 and the second power ports 36 facilitate a plurality of electronic devices to be powered with the first power ports 32 and the second power ports 36. Additionally, the member 24 can be bent in a variety of directions to facilitate the power housing 30 to be positioned in a variety of locations. In this way the power housing 30 can be positioned at an optimal location to facilitate the electronic devices to be plugged into the power housing 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electrical extending assembly for facilitating a variety of types of electrical plugs to be electrically coupled to a single power source, said assembly comprising:
a power plug having a plurality of male contacts each being configured to be plugged into a power source comprising a female electrical outlet;
a member being coupled to and extending away from said power plug, said member being comprised of a flexible material thereby facilitating said member to be formed into a variety of shapes; and
a power housing being coupled to said member, said power housing being distally positioned with respect to said power plug wherein said power housing is configured to be distally positioned with respect to the power source when said power plug is plugged into the power source, said power housing having a plurality of first power ports each being integrated into said power housing wherein each of said first power ports is configured to receive a first type of power cord, each of said first power ports facing in an opposite direction with respect to said male contacts on said power plug, said power housing having a plurality of second power ports each being integrated into said power housing wherein each of said second power ports is configured to receive a second type of power cord, each of said second power ports facing in a different direction than each of said first power ports.

2. The assembly according to claim 1, wherein:
said power plug has a front face, a rear face and a perimeter surface extending between said front face and said rear face, each of said male contacts extending away from said front face, each of said male contacts being comprised of an electrically conductive material;
said member has a first end and a second end, said first end being coupled to said perimeter surface of said power plug; and
said power housing has a rear wall and an outer wall, said outer wall having a first lateral side, a second lateral side and a top side, said second end of said member being coupled to said first lateral side having said rear wall lying on a plane being oriented substantially coplanar with said rear face of said power plug.

3. The assembly according to claim 1, wherein:
said power plug has a front face, each of said male plugs being positioned on said front face; and
said power housing has a rear wall and an outer wall, said outer wall having a first lateral side, a second lateral side and a top side, said power housing being elongated between said first lateral side and said second lateral side;
each of said first power ports is recessed into said rear wall, each of said first power ports being in electrical communication with said plurality of male contacts on said front face of said plug.

4. The assembly according to claim 3, wherein each of said second power ports is recessed into said top side, each of said second power ports being in electrical communication with said plurality of male contacts on said front face of said plug.

5. An electrical extending assembly for facilitating a variety of types of electrical plugs to be electrically coupled to a single power source, said assembly comprising:
a power plug having a plurality of male contacts each being configured to be plugged into a power source comprising a female electrical outlet, said power plug having a front face, a rear face and a perimeter surface extending between said front face and said rear face, each of said male contacts extending away from said front face, each of said male contacts being comprised of an electrically conductive material;
a member being coupled to and extending away from said power plug, said member being comprised of a flexible material thereby facilitating said member to be formed into a variety of shapes, said member having a first end and a second end, said first end being coupled to said perimeter surface of said power plug; and
a power housing being coupled to said member, said power housing being distally positioned with respect to said power plug wherein said power housing is configured to be distally positioned with respect to the power source when said power plug is plugged into the power source, said power housing having a plurality of first power ports each being integrated into said power housing wherein each of said first power ports is configured to receive a first type of power cord, each of said first power ports facing in an opposite direction with respect to said male contacts on said power plug, said power housing having a plurality of second power ports each being integrated into said power housing wherein each of said second power ports is configured to receive a second type of power cord, each of said second power ports facing in a different direction than each of said first power ports, said power housing having a rear wall and an outer wall, said outer wall having a first lateral side, a second lateral side and a top side, said power housing being elongated between said first lateral side and said second lateral side, said second end of said member being coupled to said first lateral side having said rear wall lying on a plane being oriented substantially coplanar with said rear face of said power plug, each of said first power ports being recessed into said rear wall, each of said second power port being recessed into said top side, each of said first power ports being in electrical communication with said plurality of male contacts on said front face of said plug, each of said second power ports being in electrical communication with said plurality of male contacts on said front face of said plug.
